(19) United States
(12) Patent Application Publication
(10) Pub. No.: US 2013/0244775 A1
(43) Pub. Date: Sep. 19, 2013

(54) UNIVERSAL MOUNT CONFIGURED TO ACCOMMODATE DIFFERENT MEDIA ACCEPTORS

(71) Applicant: Edward H. Comfort, North Las Vegas, NV (US)

(72) Inventor: Edward H. Comfort, North Las Vegas, NV (US)

(21) Appl. No.: 13/420,992

(22) Filed: Mar. 15, 2012

(51) Int. Cl. A63F 13/00; G07D 7/00; G07F 7/04

(52) U.S. Cl. 463/31; 194/206

(57) ABSTRACT

A media acceptor mount facilitates mounting of a media acceptor, such as a currency validator, to a gaming machine or vending device. The media acceptor mount comprises a housing and a mounting plate which may be connected to the housing in different positions, each position causing the housing to define a different interior space size. The mount can be configured to accept media acceptors of different sizes by changing the position of the mounting plate.

### FIELD OF THE INVENTION

The present invention relates to media acceptors such as currency validators, and particularly to a mount for such acceptors.

### BACKGROUND OF THE INVENTION

Gaming machines, vending machines and similar devices are all generally configured to be operated based upon currency input by a user. In the past, such devices often only included a coin acceptor. For example, older slot machines included coin acceptors for accepting pennies, nickels, dimes, quarters and/or silver dollars.

As the cost of the goods dispensed by such vending machines increased, vending machines were modified to include currency acceptors. Likewise, gaming machines now also generally include currency acceptors, thus permitting a player to more easily provide funds to the gaming machine for wagering.

Various currency acceptors or validators have been developed. While the currency acceptors or validators all generally have the same function, the particular configuration of each currency acceptor or validator may vary, such as depending upon the company that designed the device. For example, various styles of currency acceptors or validators are manufactured by companies such as Mars Electronics, Inc. (“MEI”) and JCM Global.

Various problems arise for arise for manufacturers of gaming machines and vending devices because of the different currency validators. For example, a gaming machine manufacturer may design a gaming machine to accommodate a specific model of a currency validator which is offered by a particular company. However, during the many years of service of that gaming machine, the currency validator may fail, but no replacements may be available because the model has gone out of production. In that event, difficulties may arise because other models of currency validators may not fit the gaming machine.

In addition, different gaming machine operators (such as different casinos) may desire to utilize different currency validators. Thus, a gaming machine manufacturer may have to make two models of the same gaming machine for two different customers: one gaming machine which accommodates a currency validator from a first manufacturer and a second gaming machine which accommodates a currency validator from a second manufacturer. This, however, raises the cost and complexity of manufacturing the gaming machines.

### SUMMARY OF THE INVENTION

Aspects of the invention comprise a media acceptor mount and methods of mounting media acceptors. The media acceptor mount may be utilized to connect or mount a media acceptor to another device, such as a gaming machine or a vending machine.

The media acceptor(s) preferably comprise devices which are configured to accept media such as printed tickets, currency and/or cards. In a preferred embodiment, the media acceptor comprises a validator which is configured to validate or authenticate a media, such as paper currency, and then route the media to a storage area.

In a preferred embodiment of the invention, the media acceptor mount comprises a housing and a mounting plate. The housing may have various configurations. In one embodiment, the housing has a base, a pair of opposing, spaced first and second sides, and a front. The front may comprise a door or other movable panel.

The mounting plate is selectively connectable to the housing in at least two different positions. In a first position, the mounting plate and the housing cooperate to define an interior area or space of a first size for accepting a media acceptor of a first size. In a second position, the mounting plate and the housing cooperate to define an interior area or space of a second size (such as a size greater than the first size) for accepting a media acceptor of a second size.

In one embodiment, the position of the mounting plate may be changed from at least a first position in which the interior area has a first length between the front of the housing and the mounting plate, and a second position in which the interior area has a second length between the front housing and the mounting plate. So configured, the mount may be adjusted to accommodate media acceptors having different lengths.

In one embodiment, the mounting plate and housing may be connected via one or more mounts. For example, the housing may define a first set of mounts comprising a first set of apertures and a second set of mounts comprising a second set of apertures. The mounting plate may be connected to the housing at or via the first or second set of mounts, either with or without fasteners or other elements. In one embodiment, the mounting plate may be connected to the housing in more than two positions, such as three or more positions.

One aspect of the invention comprises a gaming or vending machine having a universal media acceptor mount. The gaming or vending machine may comprise a cabinet or housing having at least one door which selectively provides access to an interior of the machine. The media acceptor mount may be located in the interior of the gaming or vending machine. Preferably, the mount is connected to the gaming or vending machine, such by connecting fasteners to one or more brackets associated with the mount and to the cabinet or housing.

In accordance with the invention, a gaming or vending machine manufacturer can equip the gaming or vending machine with a single mount which enables the gaming or vending machine to accept different media acceptors. This allows, for example, an end user of the gaming or vending machine to associate different media acceptors with a machine, including by removing and replacing a first media acceptor having a first size with a second media acceptor having a different size.

Further objects, features, and advantages of the present invention over the prior art will become apparent from the detailed description of the drawings which follows, when considered with the attached figures.

### DESCRIPTION OF THE DRAWINGS

FIG. 1 illustrates one embodiment of a gaming machine having a media acceptor;

FIG. 2 illustrates a media acceptor;

FIG. 3 is a side view of the gaming machine illustrated in FIG. 1, illustrating the media acceptor illustrated in FIG. 2 mounted within the gaming machine via a media acceptor mount in accordance with the invention;

FIG. 4 is a front perspective view of one embodiment of a media acceptor mount in accordance with the present invention;

FIG. 5 is side view of the media acceptor mount illustrated in FIG. 4;

FIGS. 6A and 6B illustrate use of a media acceptor mount in accordance with the invention in mounting first and second media acceptors wherein a depth of the second media acceptor is greater than the depth of the first media acceptor; and

FIGS. 7A and 7B illustrate use of a media acceptor mount in accordance with the invention in mounting third and fourth media acceptors wherein a bezel extender is required.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

One embodiment of the invention is a configuration of a media acceptor mount. The mount is configured to accept at least two different media acceptors, such as media acceptors having different sizes.

The present invention has particular utility to devices which utilize media acceptors. Such devices may comprise, for example, wager-based gaming machines, vending machines and the like.

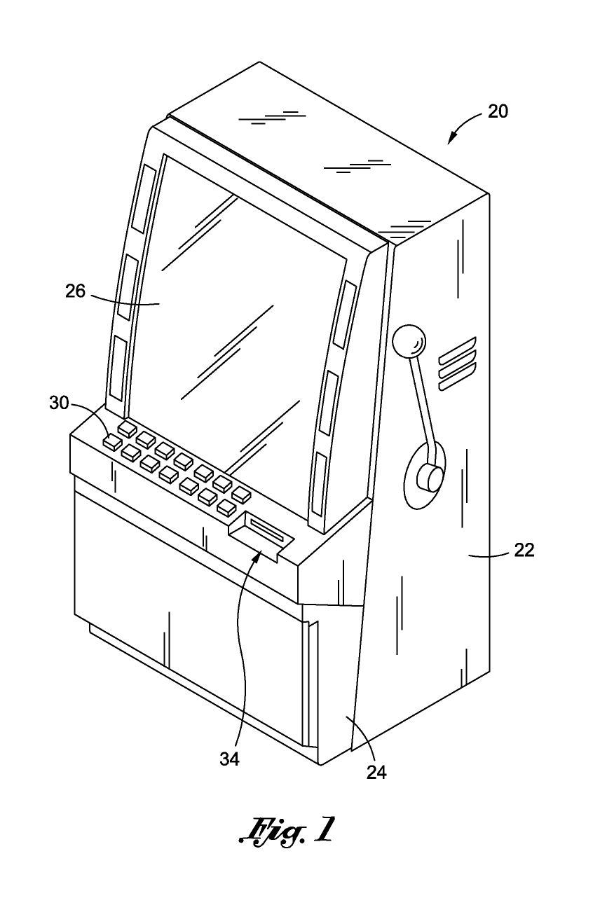

FIG. 1 illustrates one embodiment of a gaming machine 20 which comprises one environment of use of a media acceptor mount in accordance with the invention. As illustrated, the gaming machine 20 generally comprises a housing or cabinet 22 for supporting and/or enclosing various components required for operation of the gaming machine. In the embodiment illustrated, the housing 22 includes a door 24 located at a front thereof, the door capable of being moved between an open position which allows access to the interior, and a closed position in which access to the interior is generally prevented. The configuration of the gaming machine 20 may vary. In the embodiment illustrated, the gaming machine 20 has an “upright” configuration. However, the gaming machine 20 could have other configurations, shapes or dimensions (such as being of a “slant”-type or other configuration as is well known to those of skill in the art).

The size of the door 24 may vary, and in one embodiment the door 24 need not comprise the entire front of the gaming machine 20. For example, the housing 22 might define a generally closed top portion of the gaming machine 20 at the front thereof, while the door 24 might only define a lower portion of the front of the gaming machine 20.

In other embodiments, the front of the gaming machine 20 may be generally closed with limited access provided by smaller panels or doors, rather than by having a single large door control access to all or a substantial portion of the front of the gaming machine 20.

The gaming machine 20 preferably includes at least one display device 26 configured to display game information. As indicated above, the display device 26 may be a mechanical, electro-mechanical or electronic display, such as one or more rotating reels, a video display or the like. When the display device 26 is an electronic video display, as illustrated, it may comprise a cathode ray tube (CRT), high resolution flat panel liquid crystal display (LCD), projection LCD, plasma display, field emission display, digital micro-mirror display (DMD), digital light processing display (DLP), LCD touchscreen, a light emitting display (LED) or other suitable displays now known or later developed, in a variety of resolutions, sizes and formats (e.g. 4:3, widescreen or the like). The display device 26 may be capable of projecting or displaying a wide variety of information, including images, symbols and other indicia or information associated with game play, game promotion or other events. The display device 26 may be mounted to the door 24 or it may be mounted within the housing 22.

In another embodiment, the gaming machine 20 may include one or more physical reels capable of displaying symbols. In such a configuration, means are provided for rotating the physical reels. In one or more embodiments, the means may comprise a mechanical linkage associated with a spin arm, with movement of the spin arm (a “pull”) by a user causing the reels to spin. In such an arrangement, the reels are generally allowed to free-wheel and then stop. In another embodiment, electronically controlled mechanisms are arranged to rotate and stop each reel. Such mechanisms are well known to those of skill in the art. In this arrangement, actuation of the spin arm or depression a spin button causes a controller (not shown) to signal the activation of the spin mechanism associated with one or more of the reels. Preferably, the controller is arranged to either turn off the signal to the device(s) effecting the rotation of each or all of the reels or generates a signal for activating a braking device, whereby the reels are stopped. As is well known, the combinations of reel positions and their odds of hitting are associated with the controller, and the controller is arranged to stop the reels in a position displaying a combination of indicia as determined by the controller based on the combinations and odds. The principal of such an arrangement is described in U.S. Pat. No. 4,448,419 to Telnaes, which is incorporated herein by reference. For example, the base symbols might be associated with spinning reels. Sets of base symbols might be generated by spinning those reels.

As described in more detail below, the gaming machine 20 is preferably configured to present one or more games upon a player making a monetary payment or wager. In this regard, as described in more detail below, the gaming machine 20 includes means for accepting monetary value.

In one embodiment, certain game outcomes may be designated as winning outcomes. Prizes or awards may be provided for winning outcomes, such as monetary payments (or representations thereof, such as prize of credits), or promotional awards as detailed herein. As detailed below, the gaming machine 20 includes means for returning unused monetary funds and/or dispensing winnings to a player.

The gaming machine 20 preferably includes one or more player input devices 30 (such as input buttons, plunger mechanisms, a touch-screen display, joystick, touch-pad or the like). These one or more devices 30 may be utilized by the player to facilitate game play, such as by providing input or instruction to the gaming machine 20. For example, such input devices 30 may be utilized by a player to place a wager, cause the gaming machine 20 to initiate a game (such as spin slot reels), to indicate cards to be held or discarded in a game of video draw poker, to “cash out” of the gaming machine, or to provide various other inputs.

In one preferred embodiment, the gaming machine 20 includes at least one microprocessor or controller for controlling the gaming machine, including receiving player input and sending output signals for controlling the various components of the machine 20 (such as generating game information for display by the display device 26). The controller may be arranged to receive information regarding funds provided by a player to the gaming machine, receive input such as a purchase/bet signal when a purchase/bet button is depressed, and receive other inputs from a player. The controller may be arranged to generate information regarding a game, such as generating game information for display by the at least one display device 26 (such as information representing images of displayed cards, as disclosed below), for determining winning or losing game outcomes and for displaying information regarding awards for winning game outcomes, among other things.

The controller may be configured to execute machine readable code or “software” or otherwise process information, such as obtained from a remote server. Software or other instructions may be stored on a memory or data storage device. This software may be configured to implement the game described below, such as in the form of one or more steps. The memory may also store other information, such as pay table information, slot reel symbol images or the like. The gaming machine 20 may also include one or more random number generators for generating random numbers, such as for use in selecting slot reel symbols or reel stopping positions or the like for presenting the game in a random fashion.

As indicated above, the gaming machine 20 may be configured to generate and present games in a stand-alone manner or it may be in communication with one or more external devices at one or more times. For example, the gaming machine 20 may be configured as a server based device and obtain game code or game outcome information from a remote game server (in which event the gaming machine controller may receive game information from the server, such as game outcome information, and use that server-generated information to present the game at the gaming machine).

As indicated, the gaming machine 20 is configured to present one or more wagering game. Thus, the gaming machines 20 is preferably configured to accept value, such as coins, paper currency or other elements or devices representing value such as monetary funds. The gaming machine 20 might include a coin acceptor (not illustrated) for accepting coins. Of course, associated coin reading/verifying devices and coin storage devices may be associated with the gaming machine 20 if it is configured to accept coins. In a preferred embodiment, as detailed below, the gaming machine 20 includes a media acceptor, such as for accepting paper currency, printed tickets, or cards.

In one embodiment, the gaming machine 20 is configured to award winnings for one or more winning wagering game outcomes. Such winnings may be represented as credits, points or the like. In one embodiment, the player may “cash out” and thus remove previously associated funds and any awarded winnings or such may otherwise be paid to the player. For example, upon an award or at cash-out, associated funds may be paid to the player by the gaming machine 20, such as by dispensing coins to a coin tray. In another embodiment, funds may be issued by dispensing paper currency. In yet another embodiment, a player may be issued a media via a media dispenser. The media may comprise a printed ticket issued by a ticket printer or a card issued by a card dispenser, which ticket or card represents the value which was paid or cashed out of the machine.

It will be appreciated that the gaming machine illustrated in FIG. 1 is only exemplary of one embodiment of a gaming machine. For example, it is possible to for the gaming machine to have various other configurations, including different shapes and styles and having different components than as just described.

The gaming machine or device 20 may include other features. For example, the gaming machine 20 may include other displays, light, speakers for generating sounds. The gaming machine 20 might also include a top box, which top box may house or support one or more additional or secondary display devices.

In one preferred embodiment, the general electronic configuration of the gaming device is that of a processor/controller, memory device for storing program code or other data, main display device, optional secondary display device, sound card, speakers and one or more input devices. The processor is preferably a microprocessor or a microcontroller capable of displaying images, symbols and other indicia such as the faces and backs of cards. The memory device can include random access memory (RAM) for saving or accessing game data generated or used during a game. The memory device can also include read only memory (ROM) for storing program code which controls the gaming device so that a particular game is loaded and plays in accordance with appropriate game rules and pay tables. Although the processor and memory device preferably reside on each gaming device, it is also possible to provide at least some of their functionality at a central location such as a network server for communication to a playing station such as over a local area network (LAN), wide area network (WAN), Internet connection or other wireless link. With regard to generating random events (e.g., the dealing of cards), it is possible for this to occur locally (e.g., at or within the gaming device) or non-locally (e.g., centrally at a server accessed by wire or wirelessly), or a combination thereof.

As indicated above, in a preferred embodiment, the gaming machine 20 includes a media acceptor 34. The media acceptor 34 may be configured to receive and store various media, such as printed tickets or cards (and by accepting such media, may thus be referred to as a media “acceptor”). In a preferred embodiment, the media acceptor 34 is configured to receive paper currency or “bills”, validate and store that currency (and by validating such media, may thus be referred to as a media “validator”). The term “media acceptor” as used herein includes devices which validate media and are thus often referred to as media or currency validators.

One embodiment of currency-accepting media acceptor 34 is illustrated in FIG. 3. As illustrated, the media acceptor 34 has an acceptor box 36 and a currency accepting head 38. The currency accepting head 38 preferably defines a slot or opening through which currency may be accepted. The acceptor box 36 preferably defines a currency storage area, such as a bill or currency box.

When the device is configured to validate media, the media acceptor 34 preferably includes a media reader. Such a reader is preferably configured to read or scan information associated with accepted media, such as an optical reader for reading information printed on paper currency (or a magnetic stripe reader for reading information from a coded card or the like). The reader is preferably configured to validate media which has been presented to the acceptor 34. If the media is not validated, the media may be rejected. If it is accepted, it may be delivered to the storage area. In this regard, the media acceptor 34 may include various feed or transport mechanisms, such as motors, rollers and the like.

Relative to a gaming machine environment, the media acceptor 34 may be connected to or communicate with the gaming machine controller. Thus, for example, when the media acceptor receives paper currency, it may provide information to the gaming machine controller regarding the value of the accepted funds. The gaming machine controller may then indicate a number of available credits (corresponding to the value of the accepted funds) which the player may utilize in placing wagers or otherwise playing games at the gaming machine.

One embodiment of a currency validator is illustrated and described in U.S. Pat. No. 6,742,644, which is incorporated herein in its entirety. Of course, the media acceptor or validator 34 may have other configurations. For example, the media acceptor may also comprise a media dispenser (i.e. be configured to also dispense media). Relative to devices which process currency, such devices are often referred to as “currency recyclers.”

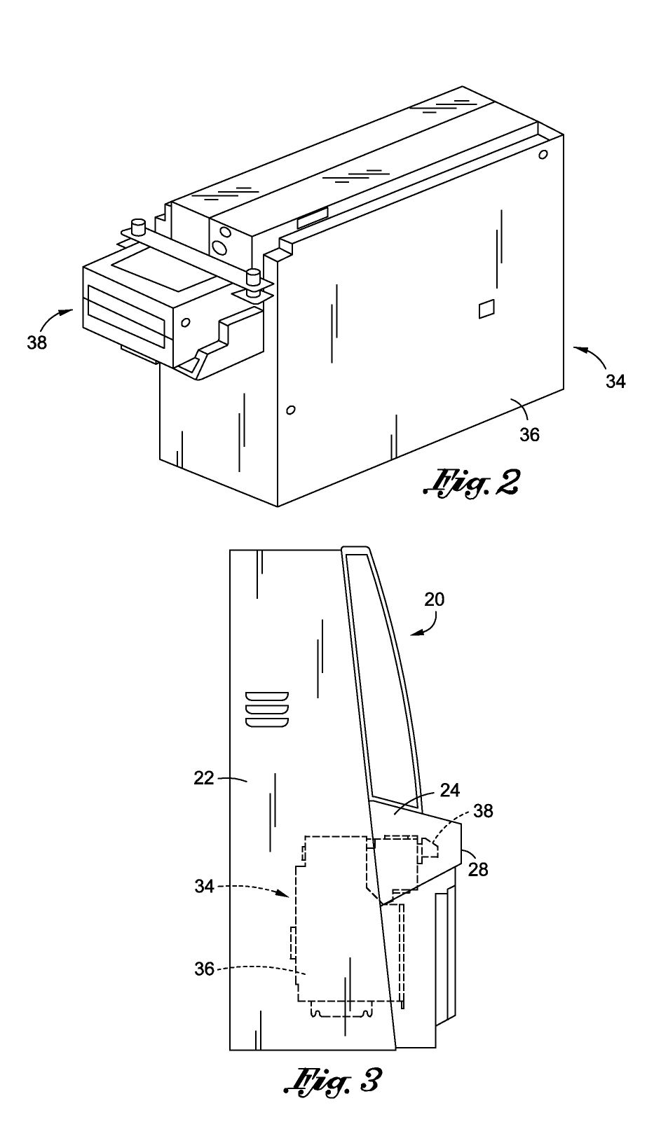

Preferably, the media acceptor 34 is mounted to the gaming machine 20 so that it is securely located in the gaming machine 20 but so that the media accepting slot is accessible to a user. For example, as illustrated in FIG. 2, the media acceptor 34 may be located within the housing 22 of the gaming machine 20, such as behind the door 24. The media acceptor 34 is thus secured within the gaming machine 20 when the door 24 is closed and locked. However, the media acceptor 34 may be accessed, such as to remove currency there from, by authorized personnel.

In one embodiment, the head 38 portion of the media acceptor 34 preferably aligns with a slot or opening in the gaming machine 20, such as in the housing 22 or door 24. In this manner, a player of the gaming machine 20 can access the media accepting slot of the media acceptor 34.

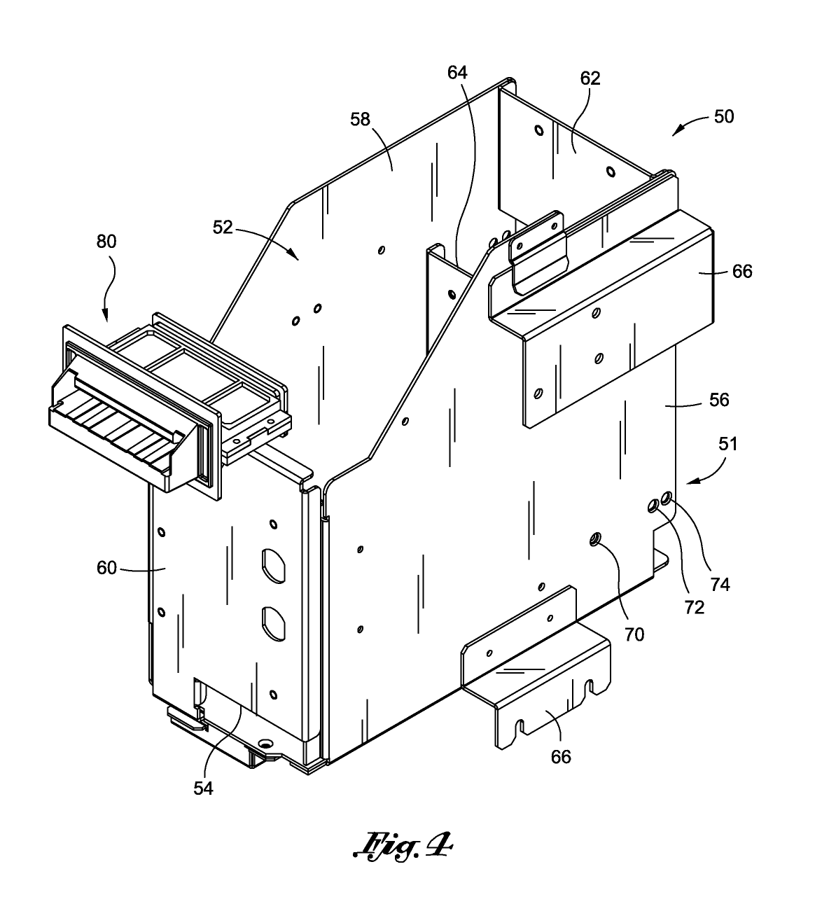

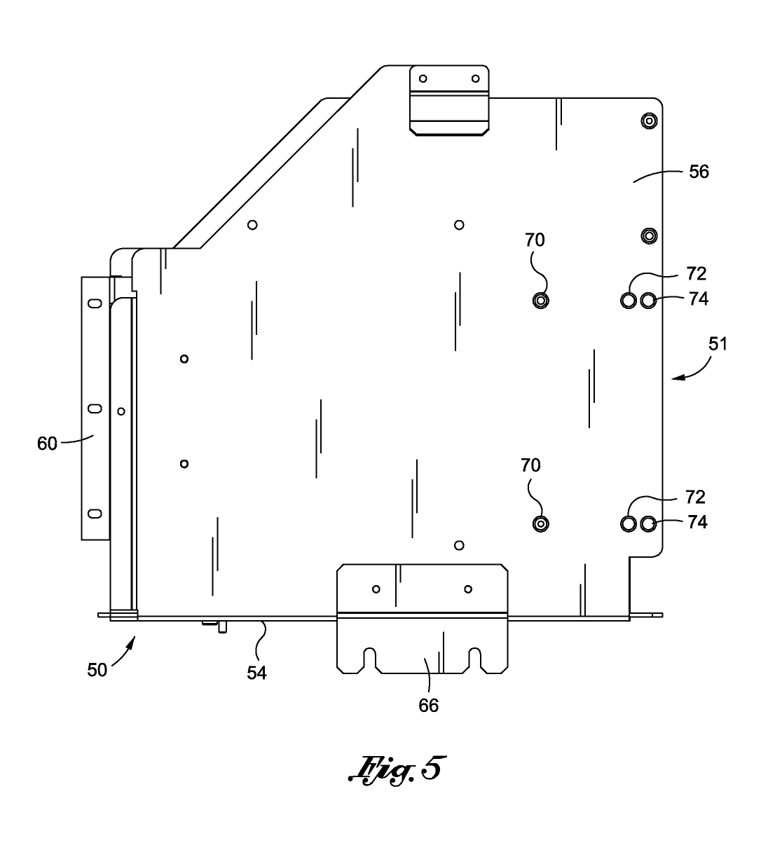

In a preferred embodiment, the media acceptor 34 is mounted to the gaming machine 20 (or other device) via a media acceptor mount 50 of the present invention. One embodiment of such a mount 50 will now be described in more detail with reference to FIGS. 4 and 5.

Referring to FIG. 4, the media acceptor mount 50 generally comprises a device for connecting a media acceptor to another device, such as a gaming machine. Preferably, the media acceptor mount 50 allows the media acceptor to be connected to the gaming machine and to be disconnected/removed from the gaming machine.

In one embodiment the mount 50 is configured to envelope or surround at least a portion of a media acceptor. In a preferred embodiment, the mount 50 thus defines an interior area 52. As described in more detail below, in a preferred embodiment, the size of at least a portion of the interior area 52 is variable, thus permitting the mount 50 accept media acceptors of different sizes.

In one embodiment, the mount 50 comprises a housing 51 which comprises a base 54 and a first side 56 and an opposing second side 58 extend upwardly from the base 54. Preferably, the first side 56 and the second side 58 are spaced from one another, thus defining a portion of the interior area 52 of the housing 51, and thus the mount 50.

In one embodiment, the housing 51 of the mount 50 includes a front panel 60. In one embodiment, the front panel 60 extends between the first side 56 and the second side 58 of the housing, thus effectively closing a front of the housing. In a preferred embodiment, the position of the front panel 60 can be changed, such as to allow access to the interior area 52 of the mount 50. The front panel 60 may thus be configured as a door which is movable from a first, closed position to a second, open position, such as via a hinged mounting. In other embodiments, the front panel 60 might be disconnectable from the housing 51 or otherwise be mounted thereto for movement. For example, the front panel 50 might be mounted to the housing 51 via mating tabs and slots or other engaging means.

In one embodiment, the housing 51 includes a rear support 62. The rear support 62 is preferably located at an opposing rear end of the housing 51 from the front panel 60. In one embodiment, the rear support 62 extends between the first side 56 and the second side 58. Preferably, the rear support 62 is short brace which is located near a top of the first side 56 and the second side 58. However, the rear support 62 may have other configurations, such as being a panel which extends from the top to the bottom of the rear end of the housing 51.

Most preferably, the mount 50 further comprises a mounting plate 64. The mounting plate 64 is selectively locatable in the interior area 52 of the mount 50. In one embodiment, the mounting plate 64 extends between the first side 56 and the second side 58 of the housing 51. As illustrated, the mounting plate 64 may be sized such that it extends upwardly from the base 54 towards the top of the first side 56 and the second side 58. As described in more detail below, in a preferred embodiment, the position of the mounting plate 64 can be varied, thus changing the effective size of the interior area 52 of the mount 50 within which a media acceptor 34 may be located.

As indicated above, the media acceptor mount 50 may be used to mount or locate a media acceptor 34 in a device such as a gaming machine or a vending machine. To this end, the media acceptor mount 50 may be mounted to the structure of such a device, such as to the housing of the gaming machine or vending machine. In one embodiment, the media acceptor mount 50 may thus include one or more mounting brackets 66. The shape, size and configuration of the one or more mounting brackets 66 may vary. As illustrated, in one embodiment a first mounting bracket 66 may be connected to bottom of the first side 56 of the housing 51, extending outwardly there from, and then extend downwardly below the housing 51. Of course, additional mounting brackets (such as associated with the second side 58 or other portion of the housing 51) may be provided. For example, FIG. 4 illustrates that the housing 51 may includes a second mounting bracket 66 which is located near the top of the first side 56 of the housing 51.

The mounting brackets 66 may be connected to an associated structure in various manners, including threaded fasteners or the like. In this regard, each mounting bracket 66 may include one or more apertures for accepting such fasteners.

The individual components of the mount 50, including the housing 51, may have various configurations. In one embodiment, as illustrated, the first side 56 and the second side 58 each have a lower or bottom edge, an opposing top edge, a front edge and an opposing rear edge. In the embodiment illustrated, the bottom edge of both the first side 56 and the second side 58 is generally straight. However, the top edge has a varying profile. In one embodiment, the elevation of the top edge of the first side 56 and the second side 58 is lower at the front of the housing 51 than the rear of the housing, such as by sloping upwardly between the front and rear of the housing. As illustrated in FIG. 3, when a media acceptor 34 is located in the housing 51, this allows the head 38 of the media acceptor 34 to extend outwardly of the housing 51.

As indicated above, in a preferred embodiment, the mount 50 includes a movable mounting plate 64. Referring to FIG. 5, in one embodiment, the mounting plate 64 can be mounted to the housing 51 in one of at least two different positions. Each position preferably defines a different effective size of the interior area 52 of the mount 50 within which a media acceptor may be located.

In one embodiment, the housing 51 defines at least first mounting position and a second mounting position for the mounting plate 64. The mounting positions may be defined by various mounts, such as fastener accepting apertures, slots or the like. For example, as illustrated in FIG. 5, the housing 51 may define a first set of apertures 70 and a second set of apertures 72. The two sets of apertures 70,72 define different mounting positions for the mounting plate 64. Preferably those mounting positions are associated with different locations of the mounting plate 64 from the front to the back of the housing 51.

For example, the first set of apertures 70 may define a front or forward-most mounting position. The second set of apertures 72 may define a second or rear mounting position.

In one embodiment, the apertures 70 correspond to mating mounts associated with the mounting plate 64. For example, the first set of apertures 70 may comprise a first pair of spaced apertures in the first side 56 of the housing 51 and a second pair of spaced apertures in the second side 58 of the housing 51. The mounting plate 64 may define corresponding pairs of apertures in opposing sides thereof. In this manner, when the apertures are aligned, fasteners may be passed through the corresponding apertures to fix the mounting plate 64 to the housing 51.

In one embodiment, the housing 51 may define more than one two mounting positions. For example, as illustrated in FIG. 5, the housing 51 may define a third set of mounts 74 which corresponds to yet another mounting position for the mounting plate 64. Of course, the housing 51 might define other numbers of mounts and mounting positions.

As indicated, the mounting plate 64 may be selectively connected to the housing 51 in the two or more mounting positions by various means for mounting. In one embodiment, the means for mounting may comprise threaded fasteners. However, other mounting configurations may be utilized. For example, the housing 51 might define pairs of slots which extend from the first side 56 and the second side 58 into the interior area 52 at various locations. The mounting plate 64 might be configured to slide into those pairs of slots. In another embodiment, the mounting plate 64 might define one or more outwardly extending tabs which are configured to engage slots in the housing 51.

In general, various means may be utilized to: (1) securely mount the mounting plate 64 in one of at least two positions relative to the housing 51; and (2) allow the position of the mounting plate 64 to be changed at one or more times. In one embodiment, the positions of the mounts are selected to define two or more desired positions for the mounting plate 64 that define: (1) a first interior area size for accepting one or more currency acceptors of a first size; and at least (2) a second interior area size for accepting one or more currency acceptors of a second size.

For example, referring to FIG. 5, the mounting plate 64 may be mounted in a first position corresponding to the first set of mounts 70. In this position, the effective size of the interior area (i.e. that portion of the mount 50 within which a currency acceptor may be located) is reduced. In this configuration, the mount 50 may accept therein a currency acceptor of a first reduced size (preferably a currency acceptor having a reduced length). However, the mounting plate 74 may also be mounted in a second position corresponding to the second set of mounts 72. In this position, the effective size of the interior area is increased (relative to the first position). In this configuration, the mount 50 may accept therein a currency acceptor of a second size which is larger than the first size (preferably a currency acceptor having an increased length).

The mount 50 may be configured so that the mounting plate 64 can be connected to the housing 51 in positions which correspond to particular sizes of media acceptors, or it might simply be configured so that the mounting plate 64 can be connected in a number of unspecific positions. For example, a gaming or vending machine manufacturer might desire that their gaming or vending machine accept a first vendor's media acceptor which has a length of 12″ and a second vendors media acceptor which has a length of 14″. In that event, the mount 50 may be configured to accept the mounting plate 64 in a first position in which the length of the interior space is 12″ (or slightly larger) or 14″ (or slightly larger). In another embodiment, the mount 50 might permit the mounting plate 64 to be mounted in positions which allow the length of the interior space to be adjusted from 10″, 12″, 14″ to 16″, thus accepting a wide range of different media acceptors (and not necessary two specific media acceptors).

In one embodiment, the mounting plate 64 might be movably connected to the housing 51. For example, the mounting plate 64 might be mounted on a track, be mounted to slide along one or more slots or grooves or the like. In this configuration, the position of the mounting plate 64 might be variously adjustable between a first end position and a second end position. For example, the mounting plate 64 might have a tab which extends into a slot in the base 54, thus permitting the mounting plate 64 to be slid along the slot. Preferably, the position of the mounting plate 64 can be fixed or secured in particular desired positions, such as by screwing a threaded fastener through a flange in the mounting plate 64 into engagement with the base 54 or the like.

In use, the currency acceptor mount 50 is preferably associated with another device, such as a gaming machine or a vending machine. The mounting plate 64 is located in a position which defines the correct size of the mount 50 relative to the currency acceptor to be used therewith. The currency acceptor is then located in the interior area 52 of the mount 50. For example, the front panel 60 may be opened, thus permitting the currency acceptor to be slid rearward into the housing 51.

Preferably, the position of the mounting plate 64 is chosen to that the interior space 52 is sufficiently large to accept the currency acceptor. At the same time, the position of the mounting plate 64 preferably causes the mount 50 to maintain the currency acceptor in a fixed position. In this regard, while a currency acceptor which would fit into the mount 50 when the mounting plate 64 is in a forward position would also fit into the mount 50 when the mounting plate 64 is in a rear position, in the latter case the currency acceptor would have room to move back and forth in the housing 51. This could cause, for example, the currency acceptor to slide backwards during use, thus causing the head 38 thereof to move out of position from the opening or slot in the associated gaming machine or vending machine, thus preventing access thereto.

Once the currency acceptor 34 is located in the mount 50, the front panel 60 may be closed or secured to maintain the currency acceptor 34 in position.

Of course, the currency acceptor mount 50 of the present invention may have other features and configurations. In one embodiment, the currency acceptor mount 50 might include one or more switch mounts, such as for one or more micro-switches (such as may be used to detect whether a currency acceptor is positioned therein or the removal of a currency acceptor there from). The currency acceptor mount 50 might include various cable mounts, access openings or other features.

In one embodiment, the mount 50, including the housing 51 may be constructed from a plurality of components which are connected to one another. For example, the first side 56 and the second side 58 may each comprise panels which are connected to the base 54. In other embodiments, portions of the housing 51 may be molded as a unitary element. In one embodiment, the primary components of the mount 50 are constructed of metal, but other materials may be utilized.

In a preferred embodiment of the invention, the position of the mounting plate 64 determines a length of the interior space of the mount 50 between the front panel 60 and the mounting plate 64. In other embodiments, it could be possible for the mount 50 to have a fixed rear plate and a movable front plate.

In other embodiments of the invention the width of the mount 50 might be variable or both the width and length of the mount 50 might be variable. For example, the position of one or both sides might be variable.

It is also possible for the housing 51 to have other configurations. For example, it may be possible for the housing 51 to not include sides or a base. For example, the front panel 60 might be mounted to the base 54. The mounting plate 64 might also be selectively mounted to the base 54 in two or more different positions. Lateral support or containment of a media acceptor 34 might be provided by flanges or other elements which extend outwardly from the front panel 60 or mounting plate 64 along the sides of the media acceptor 34.

In other embodiments, the media acceptor 34 may be secured to the mount 50 via one or more fasteners. For example, once a media acceptor 34 is located in the housing 51, one or more fasteners might be used to directly connect the media acceptor 34 to the housing 51.

As described below, aside from providing a media acceptor mount 50 which is adapted to accept media acceptors of different sizes, the present invention solves the problem of maintaining a media acceptor in alignment with a media accepting slot or opening. As described above and as illustrated in FIG. 1, a gaming machine 20 (or other device such as vending machine) preferably defines a media accepting slot or opening. For example, a gaming machine 20 may define a slot or opening in the door 24, the cabinet 22 or other structure thereof, which slot or opening permits a user to input a media to the media acceptor 34 (for example, the media accepting head of a media acceptor may be located in the opening in the gaming machine or a slot in the gaming machine may lead to the head of the media acceptor). It will be appreciated that the gaming machine 20 or other device is configured so that the media acceptor 34 is positioned to cooperate with the slot or opening, such as by having the media acceptor 34 be located in a particular position within the housing 22 such that the head 38 thereof is located at/in the opening and/or aligned with the slot.

When considering a prior art gaming machine which is custom-configured to utilize a media acceptor of a particular configuration, one problem which arises is simply that a media acceptor of a different size cannot be accommodated. However, another problem that arises relates to alignment of the head of a substitute media acceptor with the slot or opening in the gaming machine or other device. In particular, even if the gaming machine included sufficient space to permit a larger media acceptor to be located therein (such as in the interior of the housing), the media accepting head 38 thereof may no longer be in alignment with the media accepting slot or opening in the gaming machine (for example, the head 38 might protrude too far outwardly and interfere with the gaming machine's door or it might be positioned too far back so that it is not longer accessible to a user at the opening in the gaming machine or via the slot therein). As described below, the present invention solves this problem.

As an additional aspect of the invention, as illustrated in FIG. 4, the media acceptor mount 50 may include a bezel extender 80. The bezel extender 80 preferably comprises a body which may be selectively connected to a media acceptor 34. The body of the bezel extender 80 preferably defines a slot there through which aligns with the slot of the media accepting head 38 of the media acceptor 34. In this manner, when the bezel extender 80 is connected to a media validator 34, it effectively lengthens the media accepting slot, thus changing the position of the front of the slot. The bezel extender 80 can have various configurations, including depending upon the particular media acceptor 34 with which it is to be used and/or the gaming machine or other device. For example, as illustrated in FIG. 4, a first end of the bezel extender 80 may be configured to be located in an opening in a door or housing of a gaming or vending device or the like. Thus, the size and shape of that end of the bezel extender 80 may vary depending upon the size or other configuration of the opening in the gaming or vending device. Likewise, the opposing second end of the bezel extender 80 may be configured to mount or mate to a head of a media acceptor. Thus, the size and shape of that end of the bezel extender 80 may vary depending upon the configuration of the media acceptor. Lastly, it will be appreciated that the length of the bezel extender 80 may vary (so that the total length of the associated media accepting slot also varies). For example, one bezel extender 80 might have a first length L for defining an extension between an opening in a gaming machine and first media acceptor and another bezel extender 80 might have a second length L2 for defining an extension between an opening in a gaming machine and a second media acceptor (such as where the media accepting head of the first and second media acceptors are located different distances from the opening or slot in the gaming machine).

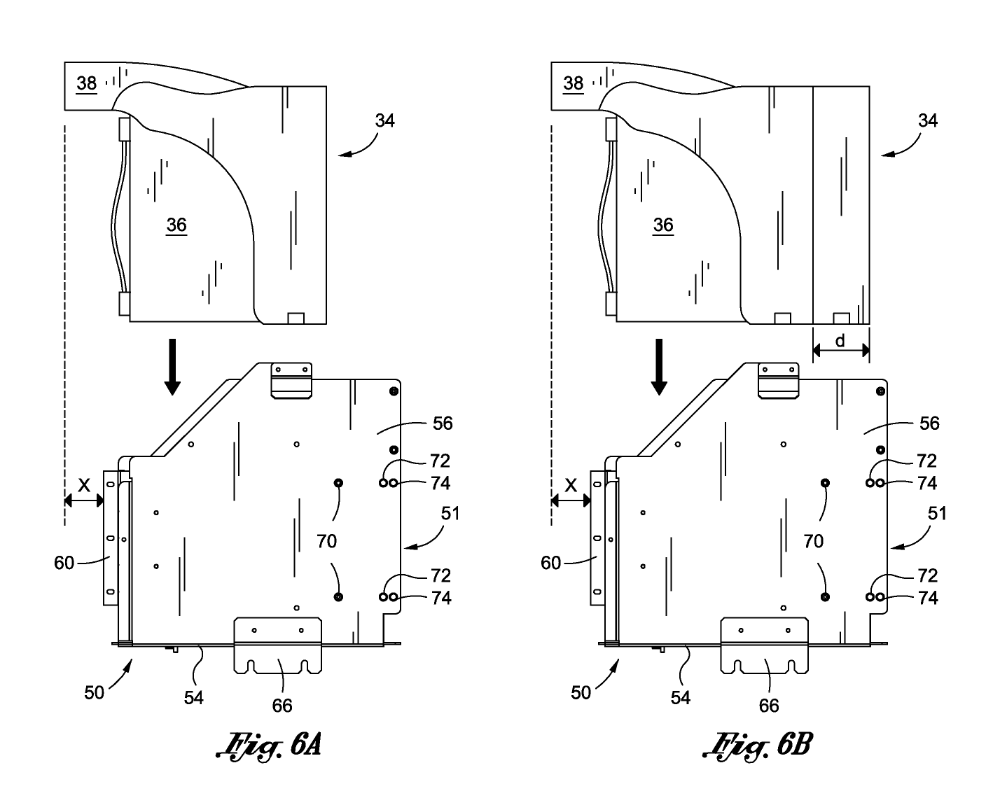

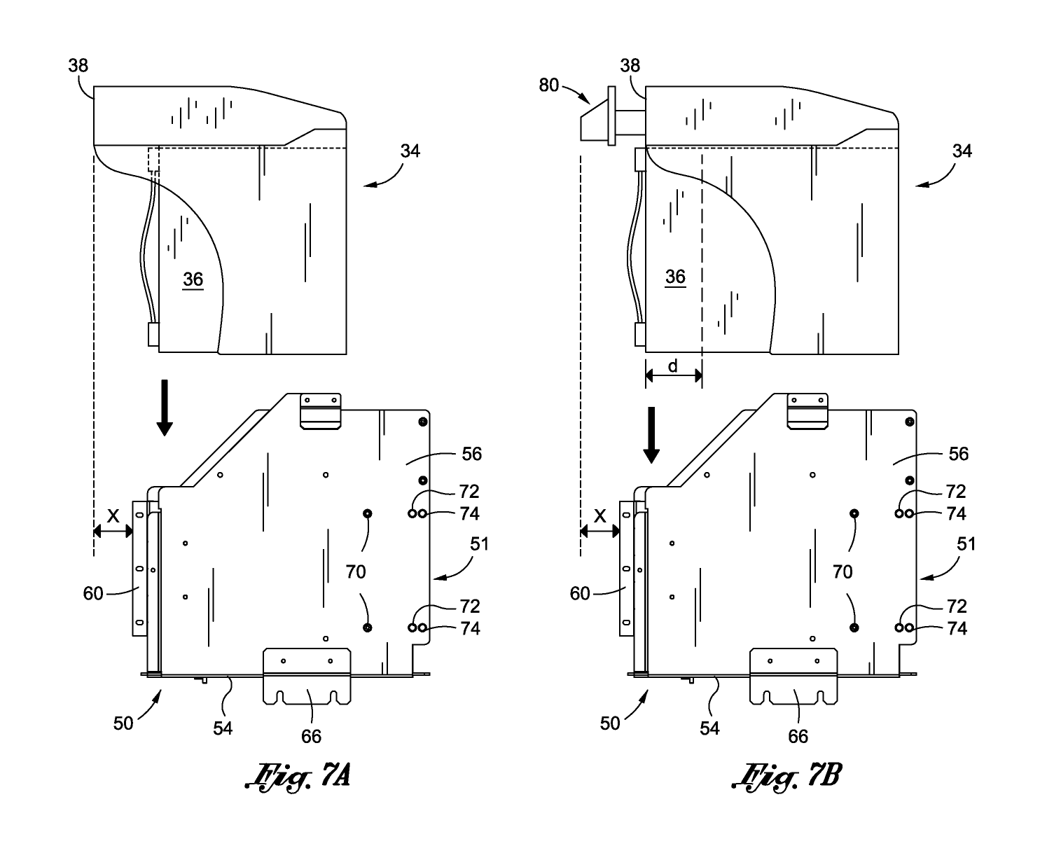

Aspects of use of the invention, including advantages thereof, will now be described with reference to FIGS. 6A, 6B, 7A and 7B. FIGS. 6A and 6B illustrate use of the invention relative to media acceptors having first and second configurations, wherein only the depth of the media acceptors varies.

FIG. 6A illustrates use of a first media acceptor 34 with the media acceptor mount 50 of the invention. This first media acceptor 34 has a first depth. Thus, the mounting plate (see FIG. 4) may be mounted in the position corresponding to mounts 70. Notably, in this position, the head 38 of the first media acceptor 34 extends forwardly of the front of the media acceptor mount 50 by a distance X, thus placing it into alignment with a slot or opening in the gaming machine or other device.

FIG. 6B illustrates use of a second media acceptor 34 which has a depth which exceeds the depth of the first media acceptor by a distance d. The second media acceptor 34 might, for example, be larger than the first so as to accommodate a larger cash box 36 (such as a 500 note vs. a 1000 note cash storage box).

As illustrated, the second media acceptor 34 is conveniently accommodated by merely changing the position of the mounting plate 64 of the media acceptor mount 50 to a rear-most position, thus increasing the effective interior size of the media acceptor mount 50. Notably, in this position, the head 38 of the media acceptor 34 still extends forwardly of the front of the media acceptor mount 50 by a distance X, thus causing the head 38 to be properly positioned relative to a slot or opening in the gaming machine or other device.

FIGS. 7A and 7B illustrate use of a third and fourth media acceptor 34 with the media acceptor mount 50 of the invention. FIG. 7A illustrates the use of the third media acceptor 34 with the media acceptor mount 50. As illustrated, the third media acceptor 34 has a first depth. Thus, the mounting plate 64 (see FIG. 4) may be mounted in the position corresponding to mounts 70. Notably, in this position, the head 38 of the media acceptor 34 extends forwardly of the media acceptor mount 50 by a distance X, thus placing it into alignment with a slot or opening in the gaming machine or other device.

FIG. 7B illustrates use of the fourth media acceptor 34. The fourth media acceptor 34 has a depth which exceeds a depth of the first media acceptor by a distance d. The second media acceptor 34 might, for example, be larger than the first so as to accommodate a larger cash box 36 (such as a 500 note vs. a 1000 note cash storage box). In this embodiment, however, the increased depth d results from the cash box 36 extending forwardly, rather than rearwardly (as in the example illustrated in FIGS. 6A and 6B).

As illustrated, the fourth media acceptor 34 is conveniently accommodated by merely changing the position of the mounting plate 64 of the media acceptor mount 50 to the second position 72, thus increasing the effective interior size of the media acceptor mount 50. However, because of the increased size of the cash box 36, the associated media accepting head 38 is now positioned generally even with the front of the media acceptor mount 50 and thus rearwardly of the position of the head illustrated in FIG. 7A by a distance X. As a result, in this configuration the extending bezel 80 is utilized, thus causing the effective location of the media accepting head 26 to be located a distance X forwardly of the front of the media acceptor mount 50, and thus properly positioned relative to a slot or opening in the gaming machine or other device.

The invention has numerous advantages. First and foremost, a gaming machine or vending machine manufacturer can configure a gaming machine or vending machine to conveniently accept media acceptors having different sizes. Preferably, the manufacturer connects the media acceptor mount of the present invention to the gaming machine or vending machine, such as within a housing thereof. The manufacturer or a user of the gaming or vending machine may associate different media acceptors with that mount. In particular, as described above, depending upon the size of the media acceptor, the manufacturer or user may move the mounting plate to cause the mount to have an interior size which corresponds to the selected media acceptor. Most importantly, the present invention not only permits media acceptors of different sizes to be located in the gaming machine or other device, but also ensures that the various differently sized media acceptors still properly align or mate with a slot or opening in the gaming machine or other device (thus, while one aspect of the invention is that the media acceptor mount can be adjusted to accommodate media acceptors of different sizes, a most important aspect of the invention is that the media acceptor mount (including via movement of the mounting plate) is configured to ensure that different media acceptors are mounted so that they are properly located in the gaming machine or other device (such as to properly align, mate or register with a slot or opening in the gaming machine or other device, either directly or by registration to a desired position that permits such alignment or mating via a bezel extender)).

In addition, a manufacturer or user of the gaming or vending machine may modify the machine by removing a media acceptor of a first size and then installing a media acceptor of a second size. In particular, the manufacturer or user may change the size of the mount from a first size to a second size so that the mount accommodates the new media acceptor.

In accordance with the invention, the cost and complexity of manufacturing a gaming or vending machine is reduced. In addition, such a gaming machine or vending machine has greater flexibility, including the potential for a longer useful life.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A gaming machine comprising:
a cabinet having an interior space;
at least one display configured to display game information based upon a wager placed by a player of said gaming machine, said display supported by said cabinet; and
a mount configured to accept a media acceptor, said mount located in said cabinet and comprising:
a housing comprising a base, a first side and a second side, said first and second sides extending upwardly from said base and fixed a spaced distance from one another, and a front panel located at a front of said housing, said front panel connected to at least one of said first side and second side; and
a mounting plate, said mounting plate connected to said housing in either of a first position or at least one second position corresponding to at least a first mount and at least one second mount, said mounting plate in said first position cooperating with said housing to define an interior space of a first size and second mounting plate in said at least one second position cooperating with said housing to define an interior space of at least one second size which differs from said first size, and wherein said position of said mounting plate may be changed between at least said first position and said at least one second position, whereby said housing may accommodate media acceptors having at least two different sizes.

2. The gaming machine in accordance with claim 1 further comprising a media acceptor located in said interior space of said housing.

3. The gaming machine in accordance with claim 2 wherein said media acceptor comprise a currency validator.

4. The gaming machine in accordance with claim 3 wherein said currency validator comprises a box and a currency accepting head, at least a portion of said box located in said interior space of said housing.

5. The gaming machine in accordance with claim 1 further comprising a game controller configured to provide said game information to said display in response to said wager.

6. The gaming machine in accordance with claim 1 wherein said cabinet defines an opening through which a slot of a media acceptor is accessible.

7. The gaming machine in accordance with claim 1 wherein said cabinet comprises a cabinet housing and at least one door, said at least one door moveable between an open position and a closed position, wherein when said door is in said open position, said media acceptor mount is accessible inside said cabinet.

8. The gaming machine in accordance with claim 1 wherein said front of said housing comprises a door which is movable between an open and a closed position.

9. The gaming machine in accordance with claim 1 further comprising at least one mount connecting said housing to said cabinet.

10. A method of mounting a media acceptor in a gaming machine comprising the steps of:
mounting a media acceptor mount to said gaming machine, said media acceptor mount comprising:
a housing comprising a base, a first side and a second side, said first and second sides extending upwardly from said base and fixed a spaced distance from one another, and a front panel located at a front of said housing, said front panel connected to at least one of said first side and second side; and
a mounting plate;
and
if said media acceptor is of a first dimension, mounting said mounting plate to said housing in a first position, said mounting plate in said first position cooperating with said housing to define an interior space of a first size;
if said media acceptor is of a second dimension which is larger than said first dimension, mounting said mounting plate to said housing in a second position, said mounting plate in said second position cooperating with said housing to define an interior space of a second size which is larger than said first size; and
locating said media acceptor in said housing of said media acceptor mount.

11. The method in accordance with claim 10 wherein said step of mounting said media acceptor mount comprising connecting said media acceptor mount to said gaming machine using at least one fastener.

12. The method in accordance with claim 11 wherein said gaming machine comprises a housing defining an interior area and at least one door which is movable between at least a first and a second position to selectively provide access to at least a portion of said interior, wherein said media acceptor mount is connected to said cabinet in said interior space.

13. The method in accordance with claim 10 wherein said steps of mounting said mounting plate to said housing comprises connecting said mounting plate to said housing utilizing at least one fastener.

14. The method in accordance with claim 10 wherein said media acceptor comprises a currency validator.

15. The method in accordance with claim 10 wherein said media acceptor of a first dimension has a first length and said media acceptor of a second dimension has a second length, said second length being greater than said first length.
